(19) United States
(12) Patent Application Publication
(10) Pub. No.: US 2024/0004079 A1
(43) Pub. Date: Jan. 4, 2024

(54) Optical Device Having Monolithic Architecture And Method For Manufacturing Same

(71) Applicant: DEEP-IN-SIGHT CO., LTD., Seongnam-si, Gyeonggi-do (KR)

(72) Inventors: Daewoong YANG, Daegu (KR); Eunsong OH, Yongin-si, Gyeonggi-do (KR)

(73) Assignee: DEEP-IN-SIGHT CO., LTD., Seongnam-si, Gyeonggi-do (KR)

(21) Appl. No.: 18/038,934

(22) PCT Filed: Nov. 12, 2021
(86) PCT No.: PCT/KR2021/016486

§ 371 Date: May 25, 2023

(30) Foreign Application Priority Data
Dec. 4, 2020 (KR) 10-2020-0168193
Feb. 18, 2021 (KR) 10-2021-0021941

(51) Int. Cl. G01S 17/894; G01S 7/481; G01B 11/25

(52) U.S. Cl. CPC G01S 17/894; G01S 7/4812; G01B 11/2513

(57) ABSTRACT

An optical device with monolithic architecture is disclosed. Specifically, in the optical device according to some embodiments of the present disclosure, the light transmitter that irradiates light and the light receiver that receives reflected light may be implemented in a monolithic architecture. A monolithic architecture may be achieved by replacing a function of an optical element consisting of a plurality of diffractive lenses having a complex structure and a large volume through an optical element which has a simple structure and generates an interference pattern or a diffusing pattern, and software reconstruction of an image.

### CROSS-REFERENCE TO RELATED APPLICATIONS

This application claims priority to and the benefit of Korean Patent Application No. 10-2020-0168193 filed in the Korean Intellectual Property Office on Dec. 4, 2020, the entire contents of which are incorporated herein by reference.

### TECHNICAL FIELD

The present disclosure relates to an optical device and a production method thereof, and more specifically, to an optical device having a three-dimensional sensing function and a production method thereof.

### BACKGROUND ART

In recent years, the interest in and utilization of object recognition technology for humans and other objects has been increasing, and various applications using the object recognition technology have become readily available to the general public through smartphones and the like. Therefore, the need to accurately identify a shape, a position, movement and the like of an object by precise three-dimensional (3D) shape recognition is gradually increasing. As one of the ways to do this, a 3D sensing technology is being attempted, which enables precise motion recognition.

3D sensing is performed by various methods, including a stereo vision camera method, a ToF camera method, and a structured light camera method. While the 3D sensing systems can implement and process arbitrary light patterns for 3D sensing, they are increasingly required to be miniaturized and to have high resolution for integration with various electronic devices. In order to accurately recognize objects from various distances, conventional optical components inevitably have complex configurations and large volumes, which affect design precision and fabrication requirements.

### SUMMARY OF THE INVENTION

The present disclosure has been made in an effort to provide an optical device with a monolithic architecture and a production method thereof.

To address the foregoing challenges, an embodiment of the present disclosure provides an optical device. The optical device includes a first substrate; a second substrate positioned on a top side of the first substrate; a light transmitter including a light source arranged on the first substrate and a light generating module arranged on the second substrate to be coaxially aligned with the light source; a light receiver including a light guide module arranged on the second substrate and a light sensing module arranged on the first substrate to be coaxially aligned with the light guide module; and a controller, in which the light generating module is configured to generate a light pattern that is irradiated to the outside of the optical device by light from the light source, the light guide module has a light transmitting layer having a predetermined pattern, and is configured to cause the light reflected from the exterior of the optical device to pass through the light transmitting layer to the light sensing module by the light pattern, the light sensing module is configured to generate a first optical image by sensing the light having passed through the light guide module, and the controller is configured to be able to generate a second optical image by reconstructing the first optical image, based on the predetermined pattern.

The optical device may further include a first support protruding upward on a portion of the first substrate, and configured to support a side surface of the second substrate to position the second substrate on the top side of the first substrate, and to accommodate the light source and the light sensing module therein.

The optical device may further include a second support protruding upward on a portion of the first substrate on an outer side of the first support and configured to accommodate the light generating module and the light guide module therein.

The optical device may further include an optical filter arranged on one side of the second substrate.

The first optical image may have an interference pattern (Moir pattern) or a diffusing pattern generated by the predetermined pattern.

The predetermined pattern may include a plurality of concentric circle patterns having different radii.

The predetermined pattern may include a symmetric lattice pattern.

The predetermined pattern may include a surface light source pattern.

The optical device may further include a driver configured to control operations of the light transmitter and the light receiver.

The optical device may include a time of flight (TOF) sensor module, a charge-coupled device (CCD) module, a complementary metal-oxide-semiconductor (CMOS) module, or a single photon avalanche diode (SPAD) module.

The light pattern generated by the light generating module may include a surface light source pattern.

To address the above problems, another embodiment of the present disclosure provides a method of producing an optical device. A method for producing an optical device including a light transmitter, a light receiver, and a controller may include: preparing a first substrate by arranging a light source that is included in the light transmitter and a light sensing module that is included in the light receiver; and preparing a second substrate by arranging a light generating module that is included in the light transmitter and coaxially aligned with the light source, and a light guide module that is included in the light receiver and coaxially aligned with the light sensing module.

The second substrate may be positioned on the top side of the first substrate.

The light generating module may be configured to generate a light pattern that is irradiated to the outside of the optical device by light from the light source.

The light guide module may have a light transmitting layer having a predetermined pattern, and may be configured to cause light reflected from the exterior of the optical device to pass through the light transmitting layer to the light sensing module by the light pattern.

The light sensing module may be configured to generate a first optical image by sensing the light having passed through the light guide module.

The controller may be configured to generate a second optical image by reconstructing the first optical image, based on the predetermined pattern.

The present disclosure can provide the optical device with a monolithic architecture and the production method thereof.

### BRIEF DESCRIPTION OF THE DRAWINGS

FIG. 1 shows a cross-sectional view of a conventional ToF camera.

FIG. 2 shows a cross-sectional view of an optical device according to some embodiments of the present disclosure.

FIG. 3 shows examples of a predetermined pattern of a light guide module according to some embodiments of the present disclosure.

FIG. 4 shows other examples of the predetermined pattern of the light guide module according to some embodiments of the present disclosure.

FIG. 5 is a view for illustrating a first optical image according to some embodiments of the present disclosure.

FIG. 6 is a view for illustrating a second optical image according to some embodiments of the present disclosure.

FIG. 7 is a flowchart for illustrating a method of producing an optical device according to some embodiments of the present disclosure.

### DETAILED DESCRIPTION

Various embodiments and/or aspects will be now disclosed with reference to the drawings. In the following description, multiple detailed matters will be disclosed to help comprehensive appreciation of one or more aspects. However, it will also be appreciated by one skilled in the art that such aspect(s) can be embodied without the detailed matters. In the following description and the accompanying drawings, specific exemplary aspects of one or more aspects will be described in detail. However, the aspects are exemplary and some of the various methods in principles of various aspects may be used and the descriptions are intended to include all of the aspects and equivalents thereof. Specifically, in “embodiment”, “example”, “aspect”, “illustration” and the like used in the present specification, it may not be construed that any aspect or design that will be described is more favorable or advantageous than other aspects or designs.

Hereinafter, the same reference numerals refer to the same or similar constitutional elements regardless of reference numerals, and overlapping descriptions thereof will be omitted. In addition, in describing an embodiment disclosed in the present specification, a detailed description of related known technologies will be omitted if it is determined that the detailed description makes the gist of the embodiment of the present specification unclear. Further, the accompanying drawings are only for easily understanding the embodiment disclosed in the present specification and the technical spirit disclosed by the present specification is not limited by the accompanying drawings.

Terminology used herein is intended to describe the embodiments and is not intended to limit the present disclosure. In this specification, singular forms also include plural forms unless specifically stated otherwise in a phrase. As used herein, “comprises” and/or “comprising” does not exclude the presence or addition of one or more other elements other than the recited elements.

Although the terms “first”, “second”, and the like are used for describing various devices or constitutional elements, these devices or constitutional elements are not limited by these terms. These terms are merely used for distinguishing one device or constitutional element from another device or constitutional element. Therefore, a first device or constitutional element described below may also be a second device or constitutional element in the technical idea of the present disclosure.

Unless otherwise defined, all terms (including technical and scientific terms) used in the present specification may be used as the meaning that may be commonly understood by one skilled in the art to which the present disclosure belongs. In addition, terms defined in commonly used dictionaries should not be interpreted in an idealized or excessive sense unless defined explicitly and specially.

The term “or” is intended to mean an inclusive “or” rather than an exclusive “or”. That is, unless otherwise specified or clear from the context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in the present specification designates and includes all available combinations of one or more items among enumerated related items.

The terms “information” and “data” used herein may often be used interchangeably.

When it is mentioned that a certain constitutional element is “connected” or “coupled” to another constitutional element, it should be understood that the certain constitutional element may be directly connected or coupled to the other constitutional element or another intervening constitutional element may be located therebetween. Conversely, when a constitutional element is referred to as being “directly connected” or “directly coupled” to another constitutional element, it is to be understood that there is no intervening constitutional element present.

The suffixes “module” and “unit” or “part” for constitutional elements used in the following description are given or used interchangeably only for ease of writing the specification, and thus do not themselves have distinct meanings or roles.

The description “a constitutional element or layer is “on” another constitutional element or layer” includes all of cases where the constitutional element or layer is formed directly on the other constitutional element or layer, and where another constitutional element or layer is interposed therebetween. In contrast, the description “a constitutional element is “directly on” another constitutional element refers to a case where there is no intervening constitutional element or layer present.

Spatially relative terms, such as “below”, “beneath”, “lower”, “above” and “upper” may be used herein to easily describe the relationship of one constitutional element to other constitutional element(s) as illustrated in the drawings. It should be understood that the spatially relative terms are intended to encompass different orientations of a device in use or operation, in addition to the orientation depicted in the drawings.

For example, a constitutional element described as “below” or “beneath” another constitutional element could be placed “above” another constitutional element if the constitutional element shown in the drawing is turned over. Thus, the exemplary term “below” or “beneath” may encompass both orientations of “above” and “below” or “beneath”. The constitutional element may also be oriented in different directions, and the spatially relative descriptors used herein may be interpreted according to the orientations.

Objects and advantages of the present disclosure and technical elements for accomplishing the objects and advantages will be apparent by referring to embodiments described below in detail in connection with the accompanying drawings. In describing the present disclosure, when the detailed description of the known functions or configurations is determined as unnecessarily obscuring the gist of the present disclosure, the detailed description will be omitted. In addition, terms described below are defined in light of functions of the present disclosure, which may vary depending on a user, the intent of an operator, a convention, or the like.

However, the present disclosure is not limited to the following embodiments and may be implemented in various forms. These embodiments are provided only to make the present disclosure complete and to fully inform one skilled in the art of the scope of the disclosure, and the present disclosure is only defined by the scope of the claims. Therefore, the definition should be made based on the contents throughout the present specification.

The scope of a method in the claims of the present disclosure arises from the functions and features described in each step, and is not affected by the order of recitation of steps in the claims unless a sequence relationship of the disclosed order in respective steps constituting the method is specified. For example, in a claim reciting a method including steps A and B, the scope of the claims is not limited to the recitation that step A must precede step B, even when step A is recited before step B.

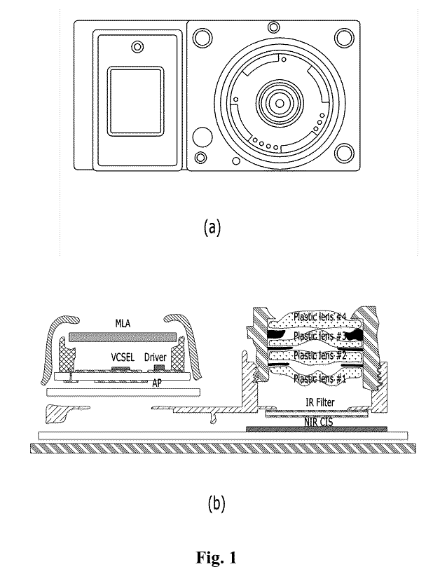

FIG. 1 shows a conventional 3D sensing camera (e.g., ToF camera) and a cross-sectional view thereof. Referring to FIG. 1, a 3D sensing camera of the related art may be produced in such a way that a light transmitter and a light receiver are produced as individual modules, which are then assembled into a single device. In the process of assembling the 3D sensing camera, it is necessary to finely adjust positions of the light transmitter and the light receiver so as to obtain desired optical characteristics, which increases the difficulty of the assembly process. In addition, an optical element consisting of a plurality of diffractive lenses that collect light from the outside has a complex configuration and occupies a large volume, as compared with other optical elements. The complex configuration and large volume of the optical element not only increase the difficulty of the assembly process and the production cost, but also adversely affect the reduction in weight/miniaturization of the product, the robustness of the product, and the design factor. Therefore, there is a demand for an optical device having a simple structure and a simple production method, as compared with the optical device of the related art.

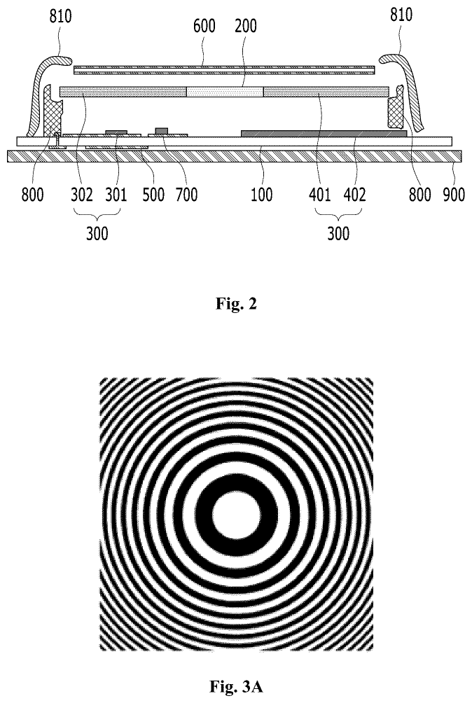

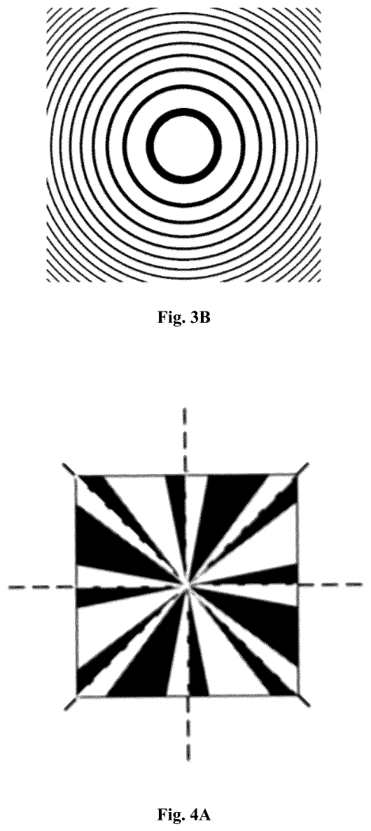

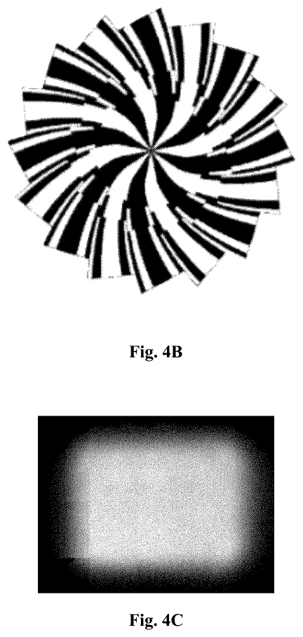

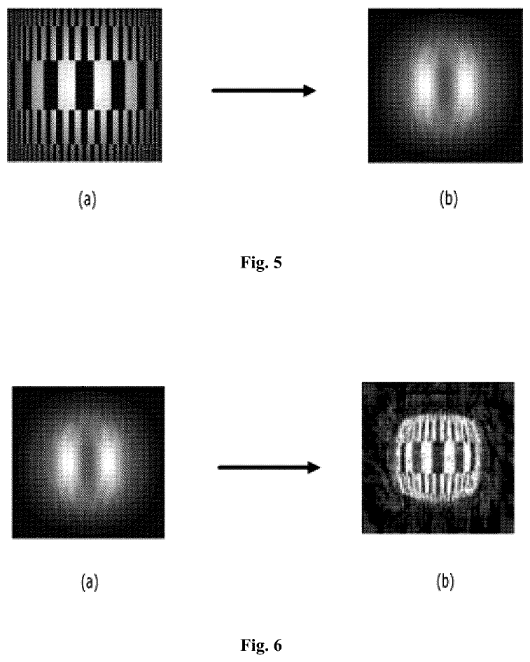

FIG. 2 shows a cross-sectional view of an optical device according to some embodiments of the present disclosure. FIG. 3 shows examples of a predetermined pattern of a light guide module according to some embodiments of the present disclosure. FIG. 4 shows other examples of the predetermined pattern of the light guide module according to some embodiments of the present disclosure. FIG. 5 is a view for illustrating a first optical image according to some embodiments of the present disclosure. FIG. 6 is a view for illustrating a second optical image according to some embodiments of the present disclosure.

In an optical device 1000 according to some embodiments of the present disclosure, a light transmitter that irradiates light and a light receiver that receives reflected light may be implemented in a monolithic architecture. Specifically, a light transmitter 300 and a light receiver 400 of the optical device 1000 may be implemented integrally on the same substrate, rather than being implemented as separate modules on separate substrates. A monolithic architecture may be achieved by replacing a function of an optical element consisting of a plurality of diffractive lenses having a complex structure and a large volume through an optical element, which has a simple structure and generates an interference pattern, and software reconstruction of an image, which will be described later. The optical device 1000 with a monolithic architecture may have a simpler product configuration and production method, as compared with the related art. Accordingly, the optical device 1000 according to the present disclosure may have low assembly and production costs and low power consumption.

The optical device 1000 may include various electronic devices such as a smart phone, a tablet, a smart watch, smart glasses, an automobile, a robot, and a drone. As another example, the optical device 1000 may be a module that may be included as one component on an electronic device. Specifically, the optical device 1000 may be a 3D sensing module (e.g., ToF sensor module) that is used in a smart phone, a tablet, smart watch, smart glasses, an automobile, a robot or a drone. In addition, the optical device may be a charge-coupled device (CCD) module, a complementary metal-oxide-semiconductor (CMOS) module, or a single photon avalanche diode (SPAD) module. In this case, the optical device 1000 may perform some operations by using several components (e.g., a processor) of the electronic device. However, the present disclosure is not limited thereto, and the optical device 1000 may include various devices.

Referring to FIG. 1, the optical device 1000 may include a first substrate 100, a second substrate 200, a light transmitter 300, a light receiver 400, a controller 500, an optical filter 600, a driver 700, a first support 800 and a second support 810. However, since the above-described constitutional elements are not essential to implement the optical device 1000, the optical device 1000 may include more or fewer constitutional elements than those listed above.

According to some embodiments of the present disclosure, the optical device 1000 may include the first substrate 100 and the second substrate 200 positioned on the top side of the first substrate. For example, the first substrate 100 and the second substrate 200 may be PCB substrates, but are not limited thereto.

The first substrate 100 may be positioned on one surface 900 of the optical device. For example, the first substrate 100 may be positioned on the top of a rear surface of a smart phone, which is the optical device 1000. In this case, the second substrate 200 may be positioned on a top side of the first substrate. As used herein, the term ‘top’ may refer to a position that is distal relative to the optical device 1000 along a direction in which light is irradiated from the optical device 1000 to the outside. Accordingly, the term ‘lower’ may refer to a position that is proximal relative to the optical device 1000 along the direction in which light is irradiated from the optical device 1000 to the outside.

The light transmitter 300 and the light receiver 400 are not implemented as separate modules on separate substrates, but may be integrally implemented on the same substrate (e.g., the first substrate 100 and the second substrate 200). To this end, the components constituting the light transmitter 300 and the light receiver 400 may be arranged at corresponding positions on the first substrate 100 or the second substrate 200, depending on a direction in which light is irradiated to the outside and a direction in which light is received from the outside.

Specifically, according to some embodiments of the present disclosure, the light transmitter 300 may include a light source 301 arranged on the first substrate 100, and a light generating module 302 arranged on the second substrate 200 so as to be coaxially aligned with the light source 301. As described above, the light transmitter 300 may be integrally implemented on the first substrate 100 and the second substrate 200 together with the light receiver 400.

The light transmitter 300 may irradiate a light pattern for 3D sensing to the outside through the light source 301 and the light generating module 302 coaxially aligned. An exemplary operation of the light transmitter 300 will be described as follows.

The light source 301 may output light having a wavelength band within a certain range. For example, the light source 301 may output IR (infrared) light. The IR light may be, for example, light having a wavelength band of 800 nm or longer. The light source 301 may include, but is not limited to, at least one laser diode, light emitting diode (LED), vertical cavity surface emitting laser (VCSEL), or edge emitting laser (EEL) for projecting light.

According to some embodiments of the present disclosure, the light generating module 302 may generate a light pattern that is irradiated to the outside of the optical device 1000 by the light from the light source 301. The light generating module 302 may include various optical elements for generating light patterns for 3D sensing. For example, the light generating module 302 may include a micro-lens array (MLA) or diffractive optical element (DOE). The light generated from the light source 301 may generate a light pattern by passing through the light generating module 302. For example, when the optical device 1000 is a ToF module, the light pattern generated by the light generating module 302 may be a surface light source pattern that is generated using a microlens array (e.g., pseudo random MLA). The surface light source pattern may be a pattern that is generated by a diffusion effect caused by a dot-like arrangement of a plurality of micro-optical elements. In addition, the light pattern may include a line pattern, a matrix pattern, a dot pattern, and the like. Further, the light pattern may include a pattern of a plurality of dots arranged uniformly or randomly. However, the present disclosure is not limited thereto, and the light pattern generated by the light generating module 302 may include various patterns.

As described above, the light source 301 and the light generating module 302 may be coaxially aligned on the first substrate 100 and the second substrate 200. As used herein, the term “aligned coaxially” may mean being positioned on the same axis along a direction in which light is irradiated from the optical device 1000 to the outside. Therefore, when the light source 301 and the light generating module 302 are coaxially aligned on the first substrate 100 and the second substrate 200, the light source 301 and the light generating module 302 may be positioned in a direction in which light irradiated from the light source 301 can pass through the light generating module 302 to the outside.

According to some embodiments of the present disclosure, the light receiver 400 may include a light guide module 401 arranged on the second substrate 200, and a light sensing module 402 arranged on the first substrate 100 so as to be coaxially aligned with the light guide module 401. As described above, the light receiver 400 may be integrally implemented on the first substrate 100 and the second substrate 200 together with the light transmitter 300.

The light receiver 400 may sense light from the outside by the light guide module 401 and the light sensing module 402 coaxially aligned, and generate an optical image. Like the light transmitter, when the light guide module 401 and the light sensing module 402 are coaxially aligned on the first substrate 100 and the second substrate 200, the light guide module 401 and the light sensing module 402 may be positioned in a direction in which light incident from the outside can pass through the light guide module 401 and reach the light sensing module 402.

An exemplary operation of the components of the light receiver 400 will be described as follows.

According to some embodiments of the present disclosure, the light guide module 401 may have a light transmitting layer having a predetermined pattern. In addition, the light guide module 401 may cause light reflected from the outside of the optical device 1000 to pass through the light transmitting layer to the light sensing module 402 by the light pattern.

The light guide module 401 may be, for example, a transmissive film having a light transmitting layer imprinted in a predetermined pattern. The light guide module 401 may be a phase mask having a light transmitting layer with a predetermined pattern and configured to cause a phase shift of incident light. In this case, the light guide module 401 may cause light incident from the outside to have an interference pattern (Moir pattern) generated according to the predetermined pattern. The interference pattern may include an interference fringe, a wave fringe, a lattice fringe, and the like. The interference pattern may refer to stripes visually created based on difference in period when regularly repeating shapes are combined many times over. The light forming such an interference pattern may be sensed by the light sensing module 402 and used to generate a first optical image.

As another example, the light guide module 401 may be a micro-optical element having a light transmitting layer with a predetermined pattern. In this case, the light guide module may cause light incident from the outside to have a ‘diffusing pattern’ by a structure of the micro-optical element (e.g., dot structure). The light forming the diffusing pattern may be sensed by the light sensing module 402 and used to generate the first optical image. The predetermined pattern of the light transmitting layer may have various patterns. For example, referring to FIGS. 3a and 3b, the predetermined pattern may include a plurality of concentric circle patterns having different radii. Here, the plurality of concentric circle patterns may have various radii. In addition, intervals between neighboring concentric circles may have various distances. The description of the plurality of concentric circle patterns is found in Japanese Patent Application No. 2016-240818 (filing date: 2016.12.13, Applicant: HITACHI LTD), which is incorporated herein by reference in its entirety.

Referring to FIGS. 4a and 4b, the predetermined pattern of the light transmitting layer may include a symmetrical lattice pattern (generally, a symmetry of an odd number of lattices). Referring to FIG. 4a, the predetermined pattern may be a symmetrical lattice pattern configured in the form of straight lines. Referring to FIG. 4b, the predetermined pattern may be a symmetric lattice pattern configured in the form of curves. The description of the symmetric lattice patterns is found in U.S. Patent Application No. 15-547155, filing date: 2016.12.13, Applicant: Rambus Inc.), which is incorporated herein by reference in its entirety.

Referring to FIG. 4c, the predetermined pattern of the light transmitting layer may include a surface light source pattern. As shown in FIG. 4c, the surface light source pattern may be a pattern that is generated by a diffusion effect caused by a dot-like arrangement of a plurality of micro-optical elements.

However, the present disclosure is not limited thereto, and the predetermined pattern of the light transmitting layer may have various patterns other than the patterns described above. For example, the predetermined pattern may include a line pattern, a matrix pattern, a dot pattern, and the like. In addition, the predetermined pattern may include a pattern of a plurality of dots arranged uniformly or randomly. Since the predetermined pattern causes light having passed through the light guide module 401 to have an interference pattern or a diffusing pattern according to the predetermined pattern, the predetermined pattern may be used as a basis for reconstructing the first optical image by the controller 500.

According to some embodiments of the present disclosure, the light sensing module 402 may generate the first optical image by sensing light having passed through the light guide module 401. In addition, the controller 500 may generate a second optical image by reconstructing the first optical image, based on the predetermined pattern.

The light sensing module 402 may convert incoming light into an electrical signal. The light sensing module 402 may be an image sensor including a photo diode or a complementary metal-oxide semiconductor (CMOS). For example, the light sensing module 402 may be configured to sense a wavelength band of light (e.g., a wavelength band of IR light) irradiated from the light source 301.

As described above, the predetermined pattern of the light transmitting layer may cause the light passing through the light guide module 401 to form a specific interference pattern or diffusing pattern according to the predetermined pattern. Such light may be sensed by the light sensing module 402 and used to generate the first optical image.

As described above, the first optical image may have an interference pattern (Moir pattern) or a diffusing pattern generated by the predetermined pattern. Referring to FIG. 5, an exemplary lattice pattern (object) as a subject is shown in (a) of FIG. 5, and a first optical image of the object is shown in (b) of FIG. 5. The predetermined pattern of the light transmitting layer used herein may be a symmetrical lattice pattern in the form of a straight line shown in FIG. 4a.

As can be seen in FIG. 5, the first optical image may have distortion caused by the interference pattern or diffusing pattern, as compared with an actual image of the subject. The distortion (or interference pattern or diffusing pattern) of the first optical image may be reduced by being reconstructed by the controller.

Specifically, the light guide module 401 may not have the same level of light condensing function as an optical element consisting of a plurality of diffractive lenses used in the ToF camera of the related art as shown in FIG. 1. However, the light having passed through the light guide module 401 has a unique interference pattern according to the predetermined pattern, and the first optical image representing the interference pattern is reconstructed according to the predetermined pattern, and resultantly, can be converted into an image that is the same as or similar to the image of the real object. In other words, the light receiver 400 of the present disclosure may generate an image of a resulting object by reconstructing the first optical image with the predetermined pattern of the light transmitting layer of the light guide module 401. Here, the image generated by reconstructing the first optical image may be referred to as a second optical image.

Referring to FIG. 6, the first optical image described in FIG. 5 is shown in (a) of FIG. 6, and the second optical image generated by reconstructing the first optical image is shown in (b) of FIG. 6. It can be seen that the second optical image shown in (b) of FIG. 6 is closer to the real object shown in (a) of FIG. 5 than the first optical image shown in (a) of FIG. 6. In other words, the optical device 1000 of the present disclosure can replace the function of the optical element of the related art consisting of the plurality of diffractive lenses by undergoing a process of reconstructing the first optical image having the interference pattern generated according to the predetermined pattern of the light transmitting layer into the second optical image.

For example, the reconstructing of the first optical image into the second optical image may include calculating, by the controller 500, a spatial frequency spectrum using a computation on the respective RGB color components of the first optical image. In this case, an image can be obtained by extracting data from a required frequency domain of the spatial frequency spectrum. Then, the intensity of the frequency spectrum can be calculated. Noise processing may be performed on the obtained image, and contrast highlighting processing and the like may be performed. The image may be output as a shot image after undergoing color balance adjustment. The output image may be a second optical image. These steps are exemplary, and any steps may be added or deleted.

An amount of computation required in the process of reconstructing the first optical image into the second optical image generally requires two orders of magnitude or less compared to a signal processing technology of the related art, which can be easily processed by a low-power/low-specification application processor. The description of the method of reconstructing the first optical image is found in Japanese Patent Application No. 2016-240818 (filing date: 2016.12.13, Applicant: HITACHI LTD), U.S. Patent Application No. 15-547155 (filing date: 2016.12.13, Applicant: Rambus Inc.), which are incorporated herein by reference in its entirety.

The controller 500 may control general operations of the optical device 1000 in addition to the above-described reconstruction operation on the first optical image. The controller 500 may process signals, data, information, and the like that are input or output through the components of the optical device 1000. For example, the controller 500 may process input information to control the light transmitter 300 and the light receiver 400 by the driver. The controller 500 may be any processor among various commercially available processors.

The reconstructed second optical image may be used for a 3D sensing operation of the optical device. For example, the controller 500 may generate depth information by using the second optical image. When the optical device is a ToF sensor module, the controller may use the second optical image to identify a difference in travel time/phase of light between the light transmitter 300 and the light receiver 400 so as to generate depth information. In this case, the controller 500 may generate depth information about an object appearing on the image. The generated depth information may be used for 3D shape recognition of an object or terrain. When the optical device 1000 is a module included as one component in an electronic device such as a smart phone, a tablet, a smart watch, smart glasses, an automobile, a robot, a drone, or the like, it may be preferable for the optical device to be processed by an external device such as any component (e.g., a processor) on the electronic device. To this end, the controller 500 may transmit the second optical image to the outside of the optical device 1000.

As described above, the optical device 1000 of the present disclosure can replace the function of the optical element of the related art consisting of the plurality of diffractive lenses by undergoing a process of reconstructing the first optical image having the interference pattern or diffusing pattern generated according to the predetermined pattern of the light transmitting layer into the second optical image. Accordingly, an optical element consisting of a plurality of lenses having a complex structure and a large volume can be replaced with the light guide module 401 having a simple structure and a small volume. The light guide module 401 may be implemented as a wiper-level optical element. Accordingly, the optical device 1000 according to the present disclosure may be implemented as a monolithic architecture on the first substrate 100 and the second substrate 200. The optical device 1000 with a monolithic architecture may have a simple product configuration and production method. Accordingly, the optical device 1000 according to the present disclosure may have low assembly cost and low power consumption.

Additional configurations of the optical device 1000 will be described below. In some embodiments of the present disclosure, the optical device 1000 may include a first support 800. Referring to FIG. 2, the first support 800 may protrude upward from a portion of the first substrate 100. In this case, the first support 800 may support a side surface of the second substrate 200. Accordingly, the first support 800 may position the second substrate 200 on the top side of the first substrate 100. In this case, the first support 800 may accommodate the light source 301 and the light sensing module 402 therein. The first support 800 may be made of a plastic or metal material, but is not limited thereto.

In some embodiments of the present disclosure, the optical device 1000 may include a second support 810. Referring to FIG. 2, the second support 810 may protrude upward from a portion of the first substrate 100 on an outer side of the first support 800. Accordingly, the second support 810 may have a shape surrounding the first support. In addition, the second support 810 may accommodate the light generating module 302 and the light guide module 401 therein. The second support 810 may be made of a plastic or metal material, but is not limited thereto.

In some embodiments of the present disclosure, the optical device 1000 may further include an optical filter 600 arranged on one side of the second substrate. The optical filter 600 may function to limit a wavelength band of light reaching the light sensing module 402. For example, when light from the light source 301 is IR light, the optical filter 600 may be configured to pass light in a wavelength band corresponding to the IR light. The optical filter 600 may be arranged on a top side of the second substrate. In this case, as shown in FIG. 2, the second support 810 may support a side surface of the optical filter part 600 such that the optical filter is positioned on the top side of the second substrate.

In some embodiments of the present disclosure, the optical device 1000 may further include a driver 700 that controls operations of the light transmitter 300 and the light receiver 400. For example, the driver 700 may adjust distances of the light source 301 and the light generating module 302 of the light transmitter 300 according to the information processed by the controller 500 (e.g., a distance to an object, an amount of incident light, and the like). In addition, the driver 700 may adjust an amount of light by blocking a part of the light irradiated from the light transmitter 300 or a part of the light incident on the light receiver 400 with a movable blocking film (not shown). In addition, the driver 700 may adjust directions (or angles) in which the light transmitter 300 and the light receiver 400 face. However, the present disclosure is not limited thereto, and the driver 700 may control various operations of the light transmitter 300 and the light receiver 400. Since the optical device 1000 of the present disclosure has a monolithic architecture, the operations of the light transmitter 300 and the light receiver 400 can be controlled by one or a relatively small number of drivers 700.

As described above, in the optical device 1000 according to some embodiments of the present disclosure, the light transmitter that irradiates light and the light receiver that receives reflected light may be implemented in a monolithic architecture. Specifically, the light transmitter 300 and the light receiver 400 of the optical device 1000 are not implemented as separate modules on separate substrates, but may be integrally implemented as a single chip on the same substrate (e.g., the first substrate 100 and the second substrate 200). A monolithic architecture may be achieved by replacing a function of an optical element consisting of a plurality of diffractive lenses having a complex structure and a large volume through an optical element, which has a simple structure and generates an interference pattern or a diffusing pattern, and software reconstruction of an image, as described above. The optical device 1000 with a monolithic architecture may have a simpler product configuration and production method, as compared with the related art. Accordingly, the optical device 1000 according to the present disclosure may have low assembly cost and low power consumption.

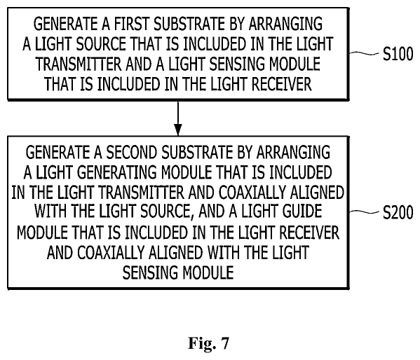

FIG. 7 is a flowchart for illustrating a method of producing an optical device according to some embodiments of the present disclosure.

As described above, the optical device 1000 of the present disclosure may have a monolithic architecture. Accordingly, the optical device 1000 of the present disclosure may have a simple product configuration and production method.

In some embodiments of the present disclosure, a method of producing an optical device 1000 including a light transmitter 300, a light receiver 400, and a controller 500 is disclosed.

In some embodiments of the present disclosure, the method of producing the optical device 1000 may include preparing a first substrate 100 by arranging a light source 301 that is included in the light transmitter 300 and a light sensing module 402 that is included in the light receiver 400 (s100). In addition, the method of producing the optical device 1000 may include preparing a second substrate 200 by arranging a light generating module 302 that is included in the light transmitter 300 and coaxially aligned with the light source 301, and a light guide module 401 that is included in the light receiver 400 and coaxially aligned with the light sensing module 402 (s200).

Accordingly, according to some embodiments of the present disclosure, the light transmitter 300 and the light receiver 400 of the optical device 1000 may be integrally produced on the same substrate. Therefore, a complex assembly method as in the production method of the optical device of the related art shown in FIG. 1, such as fabricating the light receiver and the light transmitter separately, and adjusting their respective positions, orientations or angles so as to install the two modules on a single device can be excluded.

A specific configuration of the optical device produced by the method of producing the optical device described above is as follows.

The second substrate may be positioned on the top side of the first substrate.

The light generating module 302 may generate a light pattern that is irradiated to the outside of the optical device 1000 by the light from the light source 301.

The light guide module 401 may have a light transmitting layer with a predetermined pattern. In addition, the light guide module 401 may cause light reflected from the outside of the optical device 1000 to pass through the light transmitting layer to the light sensing module 402 by the light pattern.

The light sensing module 402 may generate a first optical image by sensing the light having passed through the light guide module 401.

The controller 500 may generate a second optical image by reconstructing the first optical image, based on the predetermined pattern.

As described above, in the optical device 1000 according to some embodiments of the present disclosure, the light transmitter that irradiates light and a light receiver that receives reflected light may be implemented in a monolithic architecture. A monolithic architecture may be achieved by replacing a function of an optical element consisting of a plurality of diffractive lenses having a complex structure and a large volume through an optical element, which has a simple structure and generates an interference pattern, and software reconstruction of an image, as described above. The optical device 1000 with a monolithic architecture may have a simpler product configuration and production method, as compared with the related art. Accordingly, the optical device 1000 according to the present disclosure may have low assembly cost and low power consumption.

One skilled in the art of the present disclosure will understand that information and signals may be represented using any number of a variety of different technologies and techniques. For example, data, instructions, commands, information, signals, bits, symbols and chips that may be referenced in the above description may be represented by voltages, currents, electromagnetic waves, magnetic fields or particles, optical fields or particles, or any combination thereof.

One skilled in the art of the present disclosure will understand that the various illustrative logical blocks, modules, processors, means, circuits, and algorithmic steps described in connection with the embodiments disclosed herein may be implemented by electronic hardware, various forms of programs or design codes (referred to herein as software, for convenience) or a combination of both. To clearly illustrate this interchangeability of hardware and software, various illustrative components, blocks, modules, circuits, and steps have been described above generally with respect to their functions. Whether such functions are implemented as hardware or software depends on the specific application and the design constraints imposed on the overall system. One skilled in the art of the present disclosure may implement the functions described in varying ways for each particular application, but such implementation decisions should not be construed as departing from the scope of the present disclosure.

Various embodiments presented herein may be implemented as methods, devices, or articles of manufacture using standard programming and/or engineering technologies. The term article of manufacture includes a computer program, carrier, or media accessible from any computer-readable storage device. For example, computer-readable storage media include, but are not limited to, magnetic storage devices (e.g., hard disks, floppy disks, magnetic strips, etc.), optical disks (e.g., CDs, DVDs, etc.), smart cards, and flash memory devices (e.g., EEPROMs, cards, sticks, key drives, etc.). Additionally, the various storage media presented herein include one or more devices and/or other machine-readable media for storing information.

It is understood that the specific order or hierarchy of steps in the processes presented is an example of exemplary approaches. It is understood that the specific order or hierarchy of steps in the processes may be rearranged within the scope of the present disclosure, based on design priorities. The appended method claims present elements of various steps in a sample order, but are not intended to be limited to the specific order or hierarchy presented.

The description of the presented embodiments has been provided to allow anyone skilled in the art to use or embody the present disclosure. It will be apparent to one skilled in the art that various modifications may be made to the embodiments, and general principles defined herein may be applied to other embodiments without departing from the scope of the present disclosure. Therefore, the present disclosure is not limited to the embodiments presented herein and should be interpreted as having the broadest possible range that is consistent with the principles and novel features presented herein.

What is claimed is:

1. An optical device comprising:
a first substrate;
a second substrate positioned on a top side of the first substrate;
a light transmitter including a light source arranged on the first substrate and a light generating module arranged on the second substrate to be coaxially aligned with the light source;
a light receiver including a light guide module arranged on the second substrate and a light sensing module arranged on the first substrate to be coaxially aligned with the light guide module; and
a controller,
wherein the light generating module is configured to generate a light pattern that is irradiated to outside of the optical device by light from the light source,
wherein the light guide module has a light transmitting layer having a predetermined pattern, and is configured to cause the light reflected from exterior of the optical device to pass through the light transmitting layer to the light sensing module by the light pattern,
wherein the light sensing module is configured to generate a first optical image by sensing the light having passed through the light guide module, and
wherein the controller is configured to generate a second optical image by reconstructing the first optical image, based on the predetermined pattern.

2. The optical device of claim 1, further comprising a first support protruding upward on a portion of the first substrate, and configured to support a side surface of the second substrate to position the second substrate on top side of the first substrate, and to accommodate the light source and the light sensing module therein.

3. The optical device of claim 2, further comprising a second support protruding upward on a portion of the first substrate on an outer side of the first support and configured to accommodate the light generating module and the light guide module therein.

4. The optical device of claim 1, further comprising an optical filter arranged on one side of the second substrate.

5. The optical device of claim 1, wherein the first optical image has an interference pattern (Moir pattern) or a diffusing pattern generated by the predetermined pattern.

6. The optical device of claim 5, wherein the predetermined pattern comprises a plurality of concentric circle patterns having different radii.

7. The optical device of claim 5, wherein the predetermined pattern comprises a symmetric lattice pattern.

8. The optical device of claim 5, wherein the predetermined pattern comprises a surface light source pattern.

9. The optical device of claim 1, further comprising a driver configured to control operations of the light transmitter and the light receiver.

10. The optical device of claim 1, wherein the optical device comprises a time of flight (TOF) sensor module, a charge-coupled device (CCD) module, a complementary metal-oxide-semiconductor (CMOS) module, or a single photon avalanche diode (SPAD) module.

11. The optical device of claim 1, wherein the light pattern generated by the light generating module comprises a surface light source pattern.

12. A method of producing an optical device comprising a light transmitter, a light receiver, and a controller, the method comprising:
generating a first substrate by arranging a light source that is included in the light transmitter and a light sensing module that is included in the light receiver; and
generating a second substrate by arranging a light generating module that is included in the light transmitter and coaxially aligned with the light source, and a light guide module that is included in the light receiver and coaxially aligned with the light sensing module,
wherein the second substrate is located on a top side of the first substrate,
wherein the light generating module is configured to generate a light pattern that is irradiated to outside of the optical device by light from the light source,
wherein the light guide module has a light transmitting layer having a predetermined pattern, and is configured to cause light reflected from exterior of the optical device to pass through the light transmitting layer to the light sensing module by the light pattern,
wherein the light sensing module is configured to generate a first optical image by sensing the light having passed through the light guide module, and
wherein the controller is configured to generate a second optical image by reconstructing the first optical image, based on the predetermined pattern.
